(19) United States
(12) Patent Application Publication
(10) Pub. No.: US 2002/0105178 A1
(43) Pub. Date: Aug. 8, 2002

(54) Combination sensor systems for occupant sensing

(75) Inventors: Justin Cresswell, Lincoln Park, MI (US); Gerd Winkler, Regensburg (DE)

Correspondence Address: LAURA M. SLENZAK, SIEMENS CORPORATION, 186 WOOD AVENUE SOUTH, ISELIN, NJ, 08830, US

(73) Assignee: Siemens VDO Automotive Corporation

(21) Appl. No.: 10/041,161

(22) Filed: Jan. 8, 2002

Related U.S. Application Data
(60) Provisional application No. 60/266,243, filed on Feb. 2, 2001.

(51) Int. Cl. B60R 21/32; B60K 28/16

(52) U.S. Cl. 280/735; 180/286

(57) ABSTRACT

A method and apparatus for occupant sensing utilizes at least two independent sensing systems 60, 66. Each sensing system simultaneously generates a diagnostic signal 62, 68 and an information signal 64, 70. The information signals 64, 70 from each system are combined to determine occupant weight and position and to generate an output signal 30, which is used to control deployment of a safety restraint device, such as an airbag 26. The diagnostic signals 62, 68 from each system are compared to each other to determine system accuracy. The combination of systems 60, 66 significantly decreases the respective system complexity that is required if the system is used alone. Further, the combination of systems 60, 66 simplifies design and installation as well as providing a more standardized system that can be used in variety of seating applications.

### RELATED APPLICATION

This application claims priority to provisional application 60/266,243 filed on Feb. 2, 2001.

### BACKGROUND OF THE INVENTION

1. Field of the Invention

This invention relates to a method and apparatus for occupant sensing that combines multiple sensing systems in a vehicle seat to simultaneously provide diagnostic and occupant position and weight information.

2. Related Art

Most vehicles include airbags and seatbelt restraint systems that work together to protect the driver and passengers from experiencing serious injuries due to high-speed collisions. It is important to control the deployment force of the airbags based on the size of the driver or the passenger. When an adult is seated on the vehicle seat, the airbag should be deployed in a normal manner. If there is an infant seat or small adult/child secured to the vehicle seat then the airbag should not be deployed or should be deployed at a significantly lower deployment force. One way to control the airbag deployment is to monitor the weight of the seat occupant.

Most vehicles include safety devices such as airbags and seatbelt restraint systems, which work together to protect the driver and passengers from experiencing serious injuries due to high-speed collisions. It is important to control the deployment force of the airbags based on the size of the driver or the passenger. When an adult is seated on the vehicle seat, the airbag should be deployed in a normal manner. If there is an infant seat or small adult/child secured to the vehicle seat then the airbag should not be deployed or should be deployed at a significantly lower deployment force. One way to control the airbag deployment is to monitor the weight and position of the seat occupant.

Currently there are various types systems that use different types of sensors and mounting configurations to determine seat occupant weight and position. For example, one system uses pressure sensitive foil mats or a plurality of individual sensors mounted within a seat bottom foam cushion. One disadvantage with this type of system is that a great number of sensors are required to accurately determine the occupant weight and position. It is difficult and time consuming to mount all of these sensors in the mat or cushion. These sensors must be installed at the front, rear, left side, right side and in multiple positions in the center of the seat bottom cushion in order to sufficiently accommodate all of the various positions of a seat occupant while still providing accurate measurements. Seat cushion foam and trim designs can affect the placement of the sensors compromising sensing accuracy. Further, shifting of the occupant on the seat can dislodge or move the sensors out of their proper location, especially near the edges, which further compromises the accuracy of sensor measurements. Once the sensors are dislodged, it is difficult to reposition or replace the sensors after the seat has already been installed in the vehicle. Thus, the design, manufacturing, and installation tolerances for these sensors must be tightly controlled.

Another type of system mounts multiple sensors between various structural components on a vehicle seat, such as between a seat frame member and a seat track. The sensors include a strain gage mounted on a bendable or deflectable body portion that measures the amount of strain in the deflectable body portion resulting from a weight force being exerted on the vehicle seat. The strain measurements from each of the sensors are combined to determine the total weight of the seat occupant. One disadvantage with this type of system is that multiple sensors must be installed between the seat frame member and the seat track in order to accurately determine occupant weight and position at all possible occupant seating positions. Further, because the sensors are installed between seat structures, the sensor assemblies must be strong and durable enough to provide secure connection point within the seat assembly but must also be able to provide a sufficient amount of bending/deflection so that the strain gages can measure strain accurately over a wide range of occupant sizes. Thus, it is difficult to obtain accurate measurements low strain ranges for smaller occupants.

It is important to obtain accurate weight and position information so that the occupant can be properly classified by the system. The classification information is used to modify the deployment of the airbag. Traditionally, only one type of sensing system is installed within a vehicle seat, i.e. a vehicle seat has either a sensor mat, a load cell sensor on the tracks, or some other system, to determine occupant weight and position. Because only one type of system is used it is difficult to generate diagnostics to monitor whether or not the system is accurately determining occupant position and/or occupant weight. Inaccurate information can result in improper airbag deployment. Further, because only one type of system is used, the specifications and tolerances for sensors and the overall system mast be rigidly and tightly controlled, which significantly increases cost.

Thus, it is desirable to have an improved seat occupant weight measurement and occupant position system that provides increased accuracy and provides accurate and consistent classification over a wide range of adverse road conditions and/or occupant seating conditions, as well as overcoming any other of the above referenced deficiencies with prior art systems.

### SUMMARY OF THE INVENTION

A method and apparatus for occupant sensing utilizes at least two different sensing systems to provide increased system accuracy while simplifying design and installation. The system includes a seat assembly having a seat bottom supported by a seat structure mounted to a vehicle floor. A first sensor assembly is mounted to the seat structure and a second sensor assembly mounted to the seat structure independently from the first sensor assembly. A first weight signal is generated with the first sensor assembly and a second weight signal is generated with the second sensor assembly. The first and second weight signals are compared to each other to determine accuracy and the signals are combined to determine occupant weight and position. The occupant weight and position information is used to control deployment of a safety restraint device.

In the preferred embodiment, one of the sensor assemblies is a sensor mat used to determine weight distribution on the seat bottom and the other sensor assembly is a load cell assembly that measures the normal force exerted on the seat bottom by the occupant. Both sensor assemblies generate diagnostic signals, which are compared to each other to determine system accuracy. If the ratio of the diagnostic signals exceeds a predetermined limit, a warning signal is generated or some other indicator device is activated. Both sensors also generate information signals that are combined to determine the occupant weight and position.

The subject method and apparatus combines sensing systems resulting in decreased complexity for each system and which further facilitates design and installation of the systems for a wide variety of seating applications. Additionally, standardization occurs as sensors of common shape and size can be used in vehicle seats having different sizes. These and other features of the present invention can be best understood from the following specification and drawings, the following of which is a brief description.

### BRIEF DESCRIPTION OF THE DRAWINGS

FIG. 1 is a schematic view of a seat assembly and restraint system incorporating the subject invention.

FIG. 2 is a schematic view of a sensor system.

FIG. 3 is a schematic view of a sensor system.

FIG. 4 is a schematic diagram depicting the subject invention.

### DETAILED DESCRIPTION OF AN EXEMPLARY EMBODIMENT

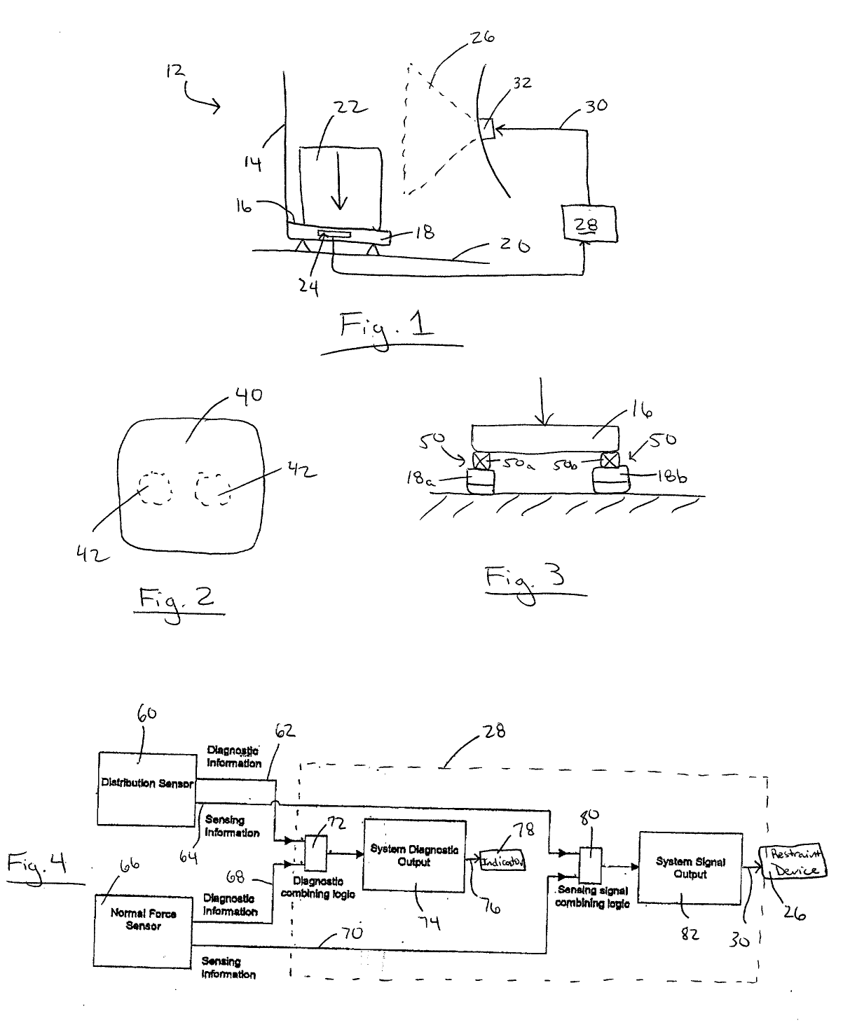

A vehicle includes a vehicle seat assembly, shown generally at 12 in FIG. 1. The seat assembly 12 includes a seat back 14 supported relative to a seat bottom 16. The seat bottom 16 is supported on a seat structure such as a track assembly 18. The track assembly 18 is mounted to a vehicle structure 20, such as a floor or riser.

A seat occupant 22 exerts a weight force F on the seat bottom 16. The seat occupant 22 can be any of various occupants including an adult, child, car seat, or any type of package or object. A combination of sensing systems, indicated generally at 24, is used to determine the weight force F and the position of the occupant 22 on the seat.

Information from the sensing systems 24 is used to control deployment of a safety restraint device, such as an airbag 26. Information from the sensing systems 24 is transmitted to a central processing unit (CPU) 28. The CPU 28 compares information from the sensing systems 24 to verify system accuracy and combines the information from the sensing systems 24 to determine weight and position of the occupant 22. This will be discussed in greater detail below. The CPU 28 then generates a control signal 30 that is transmitted to a safety restrain device control module 32 to control deployment of the restraint device 26.

The deployment force varies depending upon the type of occupant 22 that is belted to the seat 12. When an adult is belted to the vehicle seat 12, the restraint device 26 should be deployed in a normal manner shown in FIG. 1. If there is small adult or an infant in a car seat secured to the vehicle seat 12 then the restraint device 26 should not be deployed or should be deployed at a significantly lower force. Thus, it is important to be able to classify the type of occupant 22 based on weight and position information.

The subject invention determines this by using at least two (2) sensing systems that operate independently from each other. A first sensing system generates a first weight signal and a second sensing system generates a second weight signal. The weight signals are compared to each other for diagnostic purposes to determine system accuracy. The weight signals are also combined together to determine occupant weight and position for purposes of determining deployment force of the restraint system.

One of the sensing systems is preferably an occupant classification sensor (OCS) that is used to determine occupant position via weight distribution on the seat bottom 16. The other sensing system is preferably a weight classification sensor (WCS) or pressure sensor to determine occupant weight.

Preferably, one of the sensor systems is a sensor mat 40, shown in FIG. 2, installed within the seat bottom 16. The sensor mat 40 includes at least one distribution sensor 42 that is used to determine occupant position via weight distribution on the seat bottom 16 due to the weight force F exerted by the occupant 22 on the seat bottom 16. Any type of sensor mat 40 and distribution sensor 42 known in the art can be used in this application.

The other sensor system is preferably a load cell assembly 50 mounted between the seat bottom 16 and the seat track assembly 18, shown in FIG. 3. The load cell assembly 50 measures the normal force exerted on the seat bottom 16 by the occupant 22. The track assembly 18 includes an inboard assembly 18a and an outboard assembly 18b. Preferably, one load cell assembly 50a is mounted between the inboard assembly 18a and the seat bottom 16 and another load cell assembly 50b is mounted between the outboard assembly 18b and the seat bottom 16. Any type of load cell or pressure sensor known in the art can be used in this application.

Because multiple sensing systems 40, 50 are used, each system is significantly less complex then if each system 40, 50 was used alone to determine occupant weight and position. Thus, a minimal number of distribution sensors 42 are required for the sensor mat 40 and a minimal number of load cell assemblies 50 are needed to measure the normal force. Preferably, one or more distribution sensors 42 are centrally installed within the mat 40 and one load cell assembly 50 is installed at each side of the seat 12.

The method for sensing occupant weight and position is outlined in FIG. 5. A distribution sensing system 60 generates a first diagnostic signal 62 and a first information signal 64 representing weight distribution on the seat bottom 16. A normal force sensing system 66 generates a second diagnostic signal 68 and a second information signal 70 representing the normal force of the occupant 22 exerted against the seat bottom 16.

The first 62 and second 68 diagnostic signals are transmitted to a system diagnostic 72 for comparison to determine system accuracy. The system diagnostic 72 utilizes a predetermined combining logic to compare the signals 62, 68 and generate a system diagnostic output 74. The predetermined combining logic can be any number/combination of diagnostic steps that accommodate various specifications required by the federal government and/or OEM. The diagnostic output 74 is used to generate warning or error signal 76 indicating system inaccuracies. For example, if the ratio of the first 62 and second 68 diagnostic signals exceeds a predetermined limit, the error signal 76 is generated and/or an indicator 78 is activated.

The first 64 and second 70 information signals are transmitted to a system sensing signal generator 80. The system sensing signal generator 80 utilizes predetermined combining logic to combine the information signals 64, 70 and generate a system signal output 82. The predetermined combining logic can be any number/combination of diagnostic steps that accommodate various specifications required by the federal government and/or OEM. Preferably, the comparison of the first 62 and second 68 diagnostic signals and the combination of the first 64 and second 70 information signals occurs simultaneously and continuously.

The system signal output 82 is used to generate the control signal 30 for the restraint device 26. Preferably, the system diagnostic 72 and the system sensing signal generator 80 are part of a common CPU 28, however, separate CPUs could also be used.

The subject invention combines independent sensing systems for increased accuracy in occupant sensing. The subject invention overcomes problems with the complex specifications and tolerances required for single sensing systems, which must be rigidly and tightly controlled. The subject invention also overcomes diagnostic problems caused by using a single sensing where it is difficult to monitor whether or not the system is accurately determining occupant position and/or occupant weight. When multiple and independent sensing systems are used, it is possible to combine the collected information to provide reliable diagnostics for the complete system by checking the information from each sensing system against the other. The use of multiple systems allows each individual system to be less complex, which decreases cost and facilitates implementation. Also standardization is increased common sensing systems can be used in various seating applications, i.e. sensor parts can have standard shapes and sizes that can be used in different vehicle seats. System performance is also improved because the system is more robust against a single failure mode in one of the systems.

Although a preferred embodiment of this invention has been disclosed, it should be understood that a worker of ordinary skill in the art would recognize many modifications come within the scope of this invention. For that reason, the following claims should be studied to determine the true scope and content of this invention.

I claim:

1. A vehicle occupant sensing system comprising:
a seat assembly having a seat structure mountable to a vehicle floor;
a first sensor assembly mounted to said seat structure to determine weight distribution of a seat occupant on said seat structure;
a second sensor assembly mounted to said seat structure independently from said first sensor assembly to determine a normal force exerted against said seat structure by the seat occupant; and
a central processing unit for combining said weight distribution and said normal force to determine occupant weight and position and for comparing said weight distribution to said normal force to verify occupant weight and position accuracy.

2. A system according to claim 1 wherein said central processing unit generates a control signal for controlling deployment of a safety restraint device based on occupant weight and position.

3. A system according to claim 1 wherein said first sensor assembly is a sensor mat mounted within a seat bottom supported by said seat structure.

4. A system according to claim 3 wherein said sensor mat includes a single sensor assembly centrally located within said mat.

5. A system according to claim 3 wherein said second sensor assembly is a load cell assembly mounted between said seat bottom and said seat structure.

6. A system according to claim 5 wherein said seat structure is a seat track assembly including an inboard track assembly and an outboard track assembly and wherein said load cell assembly includes a single load cell mounted between said inboard track assembly and said seat structure and a single load cell mounted between said outboard track assembly and said seat structure.

7. A system according to claim 1 wherein said first sensor assembly generates a first diagnostic signal and a distribution signal and wherein said second sensor assembly generates a second diagnostic signal and a normal force signal, said central processing unit comparing said first and second diagnostic signals to generate a system diagnostic output signal and combining said distribution and normal force signals to generate a system occupant output signal.

8. A system according to claim 7 wherein said central processing unit simultaneously generates said system diagnostic and said system occupant output signals.

9. A system according to claim 7 wherein said central processing unit continuously generates said system diagnostic and said system occupant output signals.

10. A system according to claim 7 wherein said central processing unit generates a warning signal when the ratio of first and second diagnostic signals exceeds a predetermined limit.

11. A vehicle occupant sensing system comprising:
a seat assembly having a seat bottom supported on a seat track assembly mounted to a vehicle floor;
a sensor mat assembly mounted within said seat bottom to determine weight distribution of a seat occupant on said seat bottom;
a load cell assembly mounted between said seat track assembly and said seat bottom to determine a normal force exerted against said seat bottom by the seat occupant;
a central processing unit for combining said weight distribution and said normal force and generating an occupant output signal representative of occupant weight and position and for comparing said weight distribution to said normal force and generating a system diagnostic output signal representative of system accuracy; and
a safety restraint device for receiving said occupant output signal to control deployment of said safety restraint device based on occupant weight and position.

12. A system according to claim 11 wherein said sensor mat assembly generates a first diagnostic signal and a distribution signal and wherein said load cell assembly generates a second diagnostic signal and a normal force signal, said central processing unit comparing said first and second diagnostic signals to generate said system diagnostic output signal and combining said distribution and normal force signals to generate said occupant output signal.

13. A system according to claim 12 wherein said central processing unit simultaneously and continuously generates said system diagnostic and occupant output signals.

14. A system according to claim 13 wherein said central processing unit generates a warning signal when the ratio of first and second diagnostic signals exceeds a predetermined limit.

15. A method for sensing occupant weight and position relative to a vehicle seat comprising the steps of:
(a) providing a seat assembly having a seat structure mountable to a vehicle floor with a first sensor assembly mounted to the seat structure and a second sensor assembly mounted to the seat structure independently from the first sensor assembly;
(b) generating a first weight signal with the first sensor assembly;
(c) generating a second weight signal with the second sensor assembly;
(d) comparing the first weight signal to the second weight signal to determine accuracy; and
(e) combining the first and second weight signals to determine occupant weight and position.

16. The method according to claim 15 wherein generating the first weight signal in step (b) further includes generating a first diagnostic signal and a normal force signal representing a normal force exerted against the seat structure by a seat occupant, generating the second weight signal in step (c) further includes generating a second diagnostic signal and a distribution signal representing weight distribution on the seat structure, step (d) further includes comparing the first and second diagnostic signals to determine system accuracy, and step (e) includes combining the normal force and distribution signals to determine occupant weight and position.

17. The method according to claim 16 including the step of generating an error signal if the ratio of the first and second diagnostic signals exceeds a predetermined limit.

18. The method according to claim 15 wherein steps (d) and (e) occur simultaneously and continuously.

19. The method according to claim 15 including generating a control signal to control deployment of a safety device based on occupant weight and position as determined in step (e).
